(19) United States
(12) Patent Application Publication
(10) Pub. No.: US 2019/0303424 A1
(43) Pub. Date: Oct. 3, 2019

(54) Novel and innovative computer system and method for accurately and consistently automating the coding of timekeeping activities and expenses, and automatically assessing the reasonableness of amounts of time billed for those activities and expenses, through the use of supervised and unsupervised machine learning, as well as lexical, statistical, and multivariate modelling of billing entries

(71) Applicant: Ralph T. Wutscher, Chicago, IL (US)

(72) Inventor: Ralph T. Wutscher, Chicago, IL (US)

(21) Appl. No.: 15/941,851

(22) Filed: Mar. 30, 2018

(51) Int. Cl. G06F 17/22; G06Q 10/10; G06Q 50/18; G06F 17/27; G06N 20/00

(52) U.S. Cl. CPC G06F 17/22; G06Q 10/10; G06N 20/00; G06F 17/277; G06F 17/2715; G06Q 50/18

(57) ABSTRACT

This invention relates to a novel and innovative means and method to accurately and consistently classify professional services and expenses into textual, numerical, and Uniform Task Based Management System (UTBMS) or similar categories which can then be reliably used by attorneys, consultants, accountants, architects, and other professionals who bill by the hour for their services to track, analyze, and evaluate their costs, the performance of specific individuals and vendors, and other metrics. More particularly, this invention relates to a novel and innovative means and method of: (1) automating and standardizing the coding of professional activity and expenses in an accurate, consistent, and therefore useful manner; (2) automatically evaluating and standardizing billing entries through the use of lexical, statistical, and multivariate analysis, pattern matching, contextual grouping, and supervised and unsupervised machine learning of American English legal and other phrases; and (3) evaluating the reasonableness of amounts charged for specific professional activities and expenses, whether by entry or in the aggregate.

### RELATED APPLICATIONS

This application claims priority from Provisional Application Ser. No. 62/601,770 filed Mar. 31, 2017.

### FIELD OF THE INVENTION

This invention relates to a novel and innovative method and means of automating and standardizing the evaluation of the reasonableness of amounts charged for specific activities and expenses, on a task level or in the aggregate.

In addition, this invention relates to a novel and innovative method and means of automating and standardizing Uniform Task Based Management System (UTBMS) coding of legal activity and expenses in an accurate, consistent, and therefore useful manner, and applying the same means and technology in fields other than the legal field.

More particularly, this invention uses lexical, statistical, and multivariate analysis, pattern matching, contextual grouping, and supervised and unsupervised machine learning of American English legal and other phrases to accurately and consistently classify professional services and expenses into textual, numerical, and other categories which can then be reliably used by attorneys, consultants, accountants, architects, and other professionals who bill by the hour for their services, as well as by their clients, to track, analyze, and evaluate their billing, the performance of specific individuals and vendors, and other metrics.

### BACKGROUND OF THE INVENTION

This invention arose because the inventor is an attorney whose clients require the submission of bills for legal services and expenses that are coded using the Uniform Task Based Management System (UTBMS). The process for UTBMS coding is very time consuming for humans to perform, and virtually impossible to standardize when different humans are necessarily employed to do the coding.

“UTBMS (the Uniform Task Based Management System) is a series of codes used to classify legal services performed by a legal vendor in an electronic invoice submission.” (Source: http://utbms.com/) UTBMS codes were developed to better communicate in a standardized way the legal services and expenses billed by an attorney, law firm, or other vendor.

The classification of legal services and expenses via UTBMS codes also allows consumers of legal services to better track, analyze, and evaluate their legal costs, the performance of specific vendors, and other metrics.

However, the growing required use of UTBMS codes has resulted in a new burden being placed on legal vendors. Each attorney, timekeeper, or other vendor must adhere to these standards by judging whether a particular UTBMS code is valid for a given activity. When such subjective selection of UTBMS codes are performed, errors are often made.

Accuracy and consistency in the use of UTBMS codes is crucial to their utility. Idiosyncratic misclassification of legal services or expenses by using different UTBMS codes for the same or similar tasks or expenses impedes and frustrates any ability of the consumers of legal services to track, analyze, and evaluate their legal costs, the performance of specific vendors, and other metrics using UTBMS codes.

Therefore, as part of the billing and timekeeping procedures, the vendors are required to provide constant, diligent oversight of the UTBMS coding process. In addition to outright errors, often adjustments are made to the UTBMS codes based on long standing conventions of practice at these vendors.

The process of evaluating time and expense records before sending bills to clients is very time consuming and error prone, highly subjective and idiosyncratic, and virtually impossible to standardize when different humans are necessarily employed to conduct the evaluation process.

The inventor also saw the need to standardize the amounts charged for various services and expenses, in order to avoid different and confusing prices and related billing for the same or similar services or expenses, and in order make the billing process less prone to overcharging and much easier to review for payment.

Just as with UTBMS coding process, the process of proofreading and revising time and expense records before sending bills to clients is very time consuming and error prone, highly subjective and idiosyncratic, and virtually impossible to standardize when different humans are necessarily employed to do the proofreading and revision activity.

After many hours of searching and investigation, including internet searches for available or proposed solutions, and searches in publicly available patent application databases, the inventor was not able to find any automated or other solution for this problem.

The existing prior art in the area of billing entries do not address or propose any method or system for the standardization of billing entries as claimed herein.

For instance, U.S. Pat. No. 6,882,986 provides a method for the automated processing and review of invoices with the review and authorization of payments done automatically based upon prior rules entered to filter the entries.

Here, the claims are vastly different and do not rely upon the prior art in U.S. Pat. No. 6,882,986 in any respect. Specifically, the claims herein provide for the automatic and systematic review, analysis, and assessment of billing entries based not upon a filter established by rules and instead through the implementation of supervised and unsupervised machine learning, as well as lexical, statistical, and multivariate modelling.

Similarly, U.S. Pat. No. 8,229,810 addresses issues in the generation of billing entries which does not in any way relate to the innovations provided for here. U.S. Pat. No. 8,229,810 proposes an automated method for tracking billing time by a user for each discrete task. Just as with U.S. Pat. No. 6,882,986, however, U.S. Pat. No. 8,229,810 does not attempt to provide a method for the automatic standardization of reasonable amounts of time or expenses through the use of supervised or unsupervised machine learning or other computer systems. Nor does U.S. Pat. No. 8,229,810 address the automatic and standardized application of UTBMS or other billing codes through the use of supervised or unsupervised machine learning or other computer systems.

The inventor believes that an accurate and consistent automated solution would be useful for attorneys, consultants, accountants, architects, and other professionals who bill by the hour for their services, as well as for the clients of the professional services providers.

The extensive human intervention required to ensure useful, accurate, consistent, and reasonable text descriptions, amounts of time allocated, amounts charged for expenses, and UTBMS and similar classifications comes at the significant cost against operational efficiency for these professionals.

Similarly, invoices for professional services must be reviewed and examined by the clients of the professional services providers, in order to ensure accuracy, to reduce costs, and to avoid overpayment. The human intervention required by the clients also comes at the significant cost against operational efficiency.

### SUMMARY OF THE INVENTION:

The method and the system of this invention center around the innovative concepts of providing:
1. A systematic, consistent approach to guide professional service providers and their clients to make an appropriate selection, derived from an analysis of prior vetted and approved amounts of time billed, amounts charged for expenses, and UTBMS or other similarly coded entries based on lexical analysis, pattern matching, and contextual grouping of American English phrases.
2. A method of identifying and retrieving entries that are potentially mis-entered or miscoded based on user specified statistical parameters.
3. Given sufficient vetted and approved data, a method for automatically assigning the appropriate amounts of time billed, amounts charged for expenses, and UTBMS or other similar codes for new entries—interactively or as a batch process. As new qualified data becomes available, the system improves the amounts of time billed, amounts charged for expenses, and UTBMS or other similar code assignments via unsupervised machine learning.
4. A mechanism for curating new entries and having the system adjust future behavior based on supervised machine learning to facilitate unique amounts of time billed, amounts charged for expenses, and UTBMS or similar coding conventions within the context of a given professional services vendor, matter, project, or other user-definable scope of data.

### BRIEF DESCRIPTION OF DRAWING:

FIG. 1 is a flow diagram depicting the core engine of the invention. This engine evaluates new entries and makes corrections based on unsupervised and supervised machine learning.

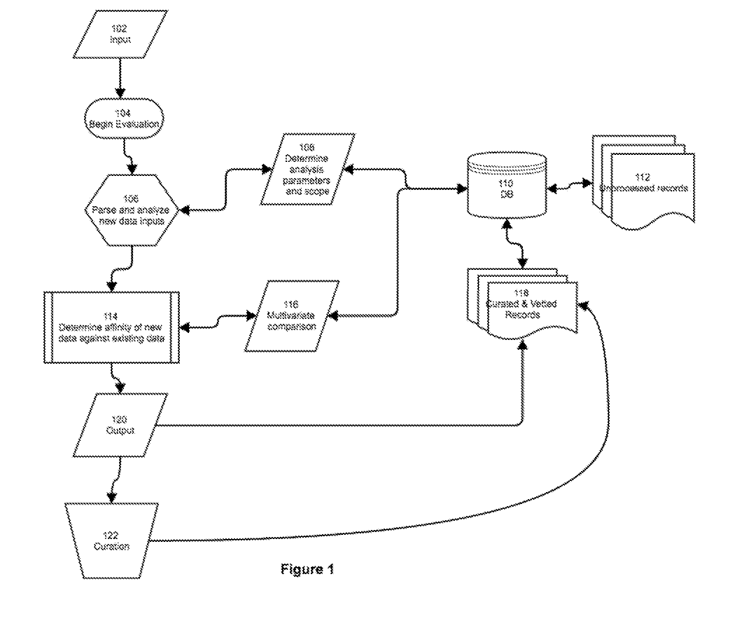

Referencing FIG. 1:

102. Input

The core engine accepts the input of American English language phrases in the form of user entry (via voice, text, or other means), extractions from emails or documents, exports of time entries or expense entries, or from interfaces to other internal/external systems (e.g., through the use of an application program interface, or “API”). The input process itself can be interactive or batched for bulk processing.

104. Begin Evaluation

Once an input has been received, an evaluation is made based on any additional metadata supplied. This additional metadata is used to determine the scope of processing to take place for the given entry. For example, an entry may need to be evaluated based on the context of other data in the system for a given professional services vendor, client, matter, project, text description, task code range, activity code range, date range, and/or user privileges. Any combination of this metadata can increase or decrease the evaluation scope. This scoping has two functions:
a. To segregate and secure sensitive data
b. To set the range of data that the engine will use recommend/correct the entry being evaluated.

106. Parse and analyze new data inputs
a. The phrase is first parsed, using a dictionary into discrete tokens, then into lexemes.
b. Once parsed, analysis parameters and scope based on meta-data (104) is retrieved (108). The original phrase and its lexemes are stored in the Database or “DB” (110) and marked as Unprocessed (112).

114. Determine affinity of new data against existing data
a. Next, a multivariate analysis (116) is performed to determine the affinity of the new record to other data in the database (again, constrained to the scope in 104). If a similarity is found, the new record is marked as belonging to that cluster of phrases. If no resemblance is found, a new cluster is instantiated and stored in the database (110).
b. Within that cluster and limited to the scope of data (as in 104), vetted phrases and their approved amount, and UTBMS or other similar coding convention activity and task codes are evaluated and a best fit is selected for the new entry using pattern matching of parsed lexemes.
c. Additionally, after the amount and UTBMS or similar code is determined, within the same scope of records, and additionally constrained to ones with the same amount, and UTBMS or similar code, a standard deviation is determined on time spent portion of the entry. The purpose of this is to further improve the quality of the data entry by examining the amount of time spent. Outliers for time spent are flagged as anomalies based on meta-data supplied in 104 or as a configuration parameter stored in the database (110).

120. Output
a. Once the core engine has finished processing, the original entry phrase and text description, amount, and UTBMS or similar code has been validated/corrected.
b. The corrected entry is added to the pool of Curated & Vetted Records (118) as part of the Unsupervised Learning process and clustered accordingly.
c. This output is made available to downstream consumers: web apps, other integrated internal/external systems (e.g. via an API), and reporting systems.

122. Curation (Supervised Learning)
a. Once processing has been completed, a system user with appropriate access as defined by the database (110) may elect to review a group of entries. The scope of these entries can be as broad or as narrow based on search filters of any of the stored data elements in the database (110) including (but not limited to) standard deviation of time entries, text descriptions, amounts, UTBMS or similar codes, system user identifiers, vendors, clients, matters, key words, etc.
b. For each record under review the user can override any text description, amount, and UTBMS or similar codes selected by the system. These updates are stored with the group of other Curated & Vetted Records (118) and will be used by the core engine for processing any new records.

It is to be understood that the above described embodiments are merely illustrative of numerous and varied other embodiments which may constitute applications of the principles of the invention. Such other embodiments may be readily devised by those skilled in the art without departing from the spirit or scope of this invention, and it is intended that such other embodiments be deemed within the scope of this invention.

### DETAILED DESCRIPTION OF THE INVENTION:

I. Data Input and Establishing a Watermark

The method starts with the input—either in the aggregate, or through separate and unique entries —of valid and accepted entries for various billing related fields which can include, but are not limited to: billing event/task/expense descriptions, totals for amount of time and money expended on each activity or expense, and related UTBMS or similar codes for the activity or expense entry or group of entries.

Given a set of known and valid entries, we initially establish “watermark” levels for lexical and statistical analysis. These parameters can be reset as needed to adjust system behavior.

These “watermark” levels can include, but are not limited to:
1. Level of acceptable similarity to consider a phrase similar or dissimilar to another group of phrases. This can be expressed as a numeric value between 0 and 1, where 0 is wholly dissimilar and 1 is lexically equivalent.
   Level of standard deviation to consider an entry's cost (time or expense) to be inside or outside the acceptable range of known valid entries, expressed as a numeric value.

II. Preparation

We begin by parsing text descriptions into distinct normalized lexemes. For example, the phrase ‘The quick brown fox jumps over the lazy dog’ would be normalized to this set of lexemes: {‘brown’, ‘dog’, ‘fox’, ‘jump’, ‘lazi’, ‘quick’}—thereby eliminating the common article words and reduce our scope of consideration to the only relevant elements.

We then store each set of lexemes with a correlating key representing the source phrase.

III. Clustering

Using the lexemes generated in the Preparation phase above, we then group phrases based on how closely they match with one another.

To begin, an arbitrary threshold is established for what is considered a positive match. This threshold will be applied, and the results observed and judged depending on the applicable data set. Any matches that fall below this threshold are considered dissimilar enough to establish a new group of phrases. This process is repeated until all the data in the given data set have been clustered.

We then:
A. Generate a unique identifier for the new cluster (assuming a match will not be found, or there are no clusters of phrases yet established).
B. Select an unprocessed phrase from the given data set and using a trigram match of lexemes and find an existing set of valid phrases that have the highest degree of coincidence at or above the pre-established threshold. Specifically:
   a. If a cluster or clusters of phrases have been found to match above the threshold, we assign the new phrase the cluster identifier of the best matching group.
   b. If no cluster is found at or above the threshold, we use the unique identifier generated above to establish a new group of similar phrases.
C. Return to Step A until all phrases have been assigned to a group.

IV. Statistical Analysis

As the supplied data set is known to represent valid phrases and appropriate costs (time or money), we can begin generating statistics within each group of valid phrases. These statistics will be used to classify the acceptability of any new data entered into the system.

As we had done in the Clustering phase, we again initially establish an acceptable level of similarity to declare a new phrase matches with a group of known good phrases.

We also establish now a threshold of variance of standard deviation. The basis for analysis is two-fold—first for judging the cost (i.e., the amount of time associated, or the monetary amount of an expense) of the new entry.

Then, given that we have a known and accurate set of valid entries with which to compare against, any new time/expense entry can be compared against similar groups of entries:
a. To identify the group or groups that the new phrase belongs to, we extract the normalized set of lexemes as in the Preparation phase.
b. This set of lexemes is matched against known good groups as described during the Clustering phase.
c. If no matching group is found, based on the established similarity threshold, we declare the new entry to be an outlier and mark it for human review.
d. If a matched group is found, we begin analyzing the new phrase against its peers.
   i. The statistical average time/expense value is calculated for the group of known valid entries. This is presented as a reference when further human review is required.
   ii. The statistical standard deviation of the new entry against the group of known valid entries is calculated and presented.
      1. If the standard deviation is beyond the threshold established above, the new entry is marked for further review.
      2. If the standard deviation is within the established threshold, the entry is marked as tentatively valid.

V. Billing Code Assignment

Our second analysis is then performed. Again, relying on the set of known valid entries, we can next assign appropriate UTBMS or similar code to the new entry. Using the established similarity threshold, we compare the new entry's lexemes to the lexemes of the known valid data set.

Then, considering the matched known valid phrases that meet or exceed the threshold:
a. If any valid phrases are found:
   i. We rank the matched phrases in order of descending similarity
   ii. We select the phrase with the highest rank, extract the billing codes and assign them to the new entry
   iii. We record the statistical lexical similarity in the new entry as a numeric score between the established threshold and 1. This expresses the overall confidence of the billing code process.
b. If no valid phrases are found:
   i. If designated in the system configuration, catch-all UTBMS (or similar) codes are assigned to the new entry
   ii. Optionally, the new entry is also marked for further human review

VI. Review

The user interface for the application provides a color-coded or similar facility for reviewing the new entries processed by the system.

Additionally, entries under review can be sorted and filtered by any data element to further facilitate systematic review of the artificial intelligence process.

At this point, an administrative user with sufficient privileges can:
A. Revise any data element of the entry
B. Re-submit the entry for the system to re-evaluate and code
C. Accept the entry valid as-is
D. Delete the entry entirely

VII. Curation

Once the administrative process has been completed, the entire set of new entries, or any part thereof, can be designated to be used for further system training. These new entries then follow the Preparation and Clustering procedures outlined above. Over time, this improves the quality and reliability of analysis and coding. The system continues to learn and refine the coding process thereby improving the evaluation and classification of future entries.

It is to be understood that the above described embodiments are merely illustrative of numerous and varied other embodiments which may constitute applications of the principles of the invention. Such other embodiments may be readily devised by those skilled in the art without departing from the spirit or scope of this invention, and it is intended that such other embodiments be deemed within the scope of this invention.

The invention claimed is:

1. A method for the use of computer software for the automatic evaluation and assignment of appropriate amounts of time billed, amounts charged for expenses, and Uniform Task Based Management System (UTBMS) or similar codes for new billing entries for work performed by attorneys, consultants, accountants, architects, and other professionals who bill by the hour for their services, comprising:
Obtaining, a database of vetted and approved data sets (individually or in bulk) for text descriptions, amounts of time billed, amounts charged for expenses, and/or UTBMS or similar codes;
Evaluating, the database of vetted and approved data employing lexical analysis, pattern matching and contextual grouping of American English phrases to generate discrete tokens and lexemes;
Obtaining, additional inputs of unapproved entries of text descriptions, amounts of time billed, amounts charged for expenses, and UTBMS or similar codes for new billing entries entered by the user;
Generating an output to the user suggesting previously approved and vetted entries for selection by the user during the user's input process of new entries concurrently during the process of obtaining additional inputs of unapproved entries from users;
Utilizing a multivariate lexical and statistical analysis to evaluate unapproved entries against the database of vetted and approved data sets to determine the affinity of the new entry to the approved database and to determine the acceptability of the new entry within the allowable range;
Generating, an output displayed to the user indicating whether or not the new data entry meets within acceptable ranges of the approved and vetted entries;
Using unsupervised and supervised machine learning to curate and maintain the database of vetted and approved data sets.

2. A method for the replacement of subjective and time-consuming personal review of amounts of time billed, amounts charged for expenses, and UTBMS or similar codes with objective rules based and automated review based upon the database of prior vetted and approved billing entries using a computer program employing supervised and unsupervised machine learning, lexical analysis, pattern matching, and contextual grouping of American English phrases.

3. A method to guide each user to make an appropriate selection, derived from an analysis of prior vetted and approved text descriptions, amounts of time billed, amounts charged for expenses, and UTBMS or similarly coded entries based on supervised and unsupervised machine learning, lexical analysis, pattern matching, and contextual grouping of American English phrases.

4. A method of identifying text descriptions, amounts of time billed, amounts charged for expenses, and UTBMS or similarly coded entries that are potentially mis-entered or miscoded based on user specified statistical parameters.

5. A computer system implementing the methods in claims 1-4, comprising;
A computer readable medium for the storing and processing of computer code;
Computer code for storing and retrieving data entries stored on a computer readable medium;
Computer code for interface through an application program interface (API);
Computer code for evaluating and parsing American English language and other phrases using lexical, statistical, and multivariate analysis, pattern matching, contextual grouping, and supervised and unsupervised machine learning;
Computer code for filtering and aggregating existing data entries as selected by the user through the API including through text and voice entry on both fixed and mobile devices and producing a report and graphical display of same;
Computer code for data entry by user through the API including through text and voice entry on both fixed and mobile devices;
Computer code for submitting queries to the database utilizing the API for retrieving specific information contained in the database and producing a report and graphical display of same; and
Computer code for identifying text descriptions, amounts of time billed, amounts charged for expenses, and UTBMS or similar entries that are potentially mis-entered or miscoded based on user specified statistical parameters and producing a graphical display of same through the API.

6. The system described in claim 5, with the storage of the system remotely and accessed by the individual user through website.

7. The system described in claim 6, with access to the API through a portable device.
